(19) United States
(12) Patent Application Publication
(10) Pub. No.: US 2017/0344966 A1
(43) Pub. Date: Nov. 30, 2017

(54) METHOD FOR THE AUTOMATED PAYMENT OF AN INTERNET-BASED PURCHASE

(71) Applicant: Q.One Technologies GmbH, Essen (DE)

(72) Inventors: Thomas HEIDELBACH, Haltern am See (DE); Carsten PUSCHMANN, Essen (DE)

(21) Appl. No.: 15/537,028

(22) PCT Filed: Dec. 16, 2015
(86) PCT No.: PCT/EP2015/080006

§ 371 Date: Jun. 16, 2017

(30) Foreign Application Priority Data
Dec. 16, 2014 (DE) 10 2014 118 736.9

(51) Int. Cl. G06Q 20/12; G06F 17/30; G06Q 20/38; G06Q 30/06

(52) U.S. Cl. CPC G06Q 20/12; G06Q 30/0635; G06F 17/30882; G06Q 20/3829; G06Q 2220/00

(57) ABSTRACT

The present invention relates to a method and a system for the automated execution and billing of an internet-based online purchase of a user. According to the invention this provides for sensitive data such as e.g. payment information, to be stored in encrypted form in a local memory of a user terminal, with permanent storage of this data in an external server system for processing the purchase transaction being avoided.

The present invention relates to a method as well as a system for the automated execution and billing of an internet-based online purchase by a user.

The purchase of goods over the internet is becoming ever more popular. Selling and buying goods over the internet offers advantages both for the vendor and the buyer. By using the medium of the internet, the vendor has access to a distinctly larger group of buyers than he would have using a shop. For this reason the vendor, by selling over the internet, is able to build up a worldwide presence using a single place of distribution and thus address a worldwide group of buyers. As regards the buyer he has the advantage of being able, independently of his place of residence or location, to choose from a most comprehensive product range. Moreover he is given the option of directly comparing the offers of different vendors with each other in a simple manner, without having to rely on actually visiting the vendors in their shops. This type of buying via the internet will from now on be called online-shopping and the vendors' offer will be called an internet shop.

A great multitude of vendors of all sorts of goods have by now established themselves on the internet. The majority of vendors specialise in a specific range of goods. As such a first online vendor offers for example only products in the field of entertainment, a second online vendor only clothing and a third online vendor only children's toys.

When a user now wants to buy a number of different products he must, of course, visit the internet shop of each vendor from which he would like to buy goods. In order to complete the purchase the user has to identify himself to each vendor/each internet shop, from which he intends to acquire goods by at least disclosing his bank details or payment method as well as his delivery address. Frequently the user has to submit additional details and set up a buyer profile in the internet shop of the vendor. In particular, when the buyer intends to buy goods from a certain internet shop only one single time, the disclosure of this information is often felt to be annoying and inconvenient.

In contrast thereto, by visiting a real department store the buyer is able to acquire goods in different departments of the store and pay for all of them together at a checkout, for example a multi-purpose checkout.

In the internet also there exist by now online department stores, which offer a larger range of goods. However, these suppliers are, as a rule, not specialised in the respective range of goods they offer, in a way that internet shops are, which offer a limited but specialised range of goods.

WO 2013/093606 A1 offers a method for the billing of an online purchase by a user, identified by the steps of:
recording an article selected for purchase by the user at a first online provider;
at least temporarily storing an article data record belonging to the article in a transmission record assigned to the online provider
recording a user's checkout message, with which the user indicates the completion of his purchase to the online provider;
recording a user's identification input for identification at a billing location;
transmitting the transmission record assigned to the online provider to the billing location different from the online provider;
recording an article selected for purchase by the user at another online provider;
at least temporarily storing an article data record belonging to the article in a transmission record assigned to the online provider;
recording a user's checkout message, with which the user indicates to the online provider the completion of his purchase;
transmitting the transmission record assigned to the online provider to the billing location different from the online provider;
recording a user's checkout message, with which the user indicates the completion of his total online purchase;
providing a summary, by the billing location, of the articles selected by the user at the online providers for at least one further user;
recording an identification input of the at least one other user for identification at a billing location;
recording a selection of an article of the at least one other user from the summary and associating the selection of the at least one further user with the transmission record of the article selected from the summary by the user;
recording a checkout message of the at least one further user;
removing the articles recorded with the selection of the at least one further user from the summary;
billing the articles recorded with the selection in relation to the at least one further user by the billing location on the basis of the transmitted transmission records; and
billing the online purchases in relation to the online providers on the basis of the transmitted transmission records.

With the method according to the invention a central shopping cart system (central shopping cart) is linked to the respective internet shop of a provider on the provider side. Corresponding cooperation of the shop provider is therefore a precondition.

The requirement of the invention therefore consists in proposing a system for processing an internet-based purchase transaction of a user, which can function independently of a shop provider's cooperation and/or can do without manipulating the programming of the product offer side in the web presence of the shop provider.

As regards the methods this requirement is met by a method according to claim 1.

To meet the requirement a method is proposed for processing a user's internet-based purchase transaction at a vendor, which comprises the following steps:
accessing a website comprising a product link of the product to be acquired by means of a browser on a user terminal by the user;
selecting the product corresponding to the product link by the user by means of a vendor-independent interaction trigger;
transmitting the product link to a web application server of a server system together with a user ID;
initiating the checkout process on the part of the user by means of a checkout trigger;
transmitting the product link as well as further user data optionally stored on the web application server to a transaction server independent of the web application server together with the username, wherein at least the encrypted payment information is not stored permanently on the transaction server;
transmitting the product link and the further user data from the transaction server to a browser simulation server independent of the transaction server, together with the username;
accessing a website by opening the product link in a web browser executed on the browser simulation server;
executing a purchasing operation regarding the product on the website on the basis of execution data stored in the browser simulation server up to the point of payment options;
query by the transaction server to the browser simulation server regarding the possibility of certain payment option;
replying to the transaction server's query regarding a certain payment option with yes or no by the browser simulation server;
if the browser simulation server replies to the query by the transaction server regarding a certain payment option with yes, the following steps are executed:
in case data is missing which is required for a certain payment option from the browser simulation server, the missing data is queried via the transaction server and the web application server from the user, and the unencrypted/decrypted payment information is transmitted via the web application server to the transaction server for encryption using a generated encryption key, the encrypted payment information being supplied via the web application server to the local memory;
retrieving the encoded payment information from the local memory via the browser by the web application server and transmitting it to the transaction server;
decrypting the encrypted payment information by means of the encryption key and passing the decrypted payment information to the browser simulation server;
if the browser simulation server replies to the query by the transaction server regarding a certain payment option with no, the transaction server queries the browser simulation server for an alternative certain payment option;
triggering a payment routine regarding the certain payment option in the web shop by the browser simulation server;
transmitting the decrypted payment information from the browser simulation server to a payment provider corresponding to the certain payment option;
query from the transaction server to the browser simulation server regarding the completion of the purchase transaction;
confirming the completion of the purchase transaction by the browser simulation server to the transaction server with yes or no;
if the reply to the transaction server's query to the browser simulation server regarding the completion of the purchase transaction is yes, a success message is transmitted to the web application server together with the username;
upon receipt of a success message by the transaction server, a success message is sent by the web application server to the user terminal (101).

According to the proposed method the central shopping cart is not directly linked to the shop, but inserted into the shop or the website mapping the product link by means of a browser extension, an app on the user terminal with which a product link is retrieved, or a snippet. Furthermore the central shopping cart process may be complemented by the consolidation-UseCase “Cloud shopping”.

According to one embodiment of the method it is provided that the username comprises an unequivocal username generated on the part of a server of the server system, which upon request by the user terminal is transmitted from the web application server to the user terminal.

According to a further embodiment of the method it is provided that the method, upstream of the step “ . . . transmission of payment information stored encrypted in the user terminal to the web application server . . . ” comprises a registration step, in which the user registers with the server system at least by supplying his email address or telephone number and the user is assigned a username, wherein the username is stored both within the server system and within the user terminal in a local memory.

According to the invention it is further provided that the registration step comprises the automated creation of an email address assigned to the user, the username and/or the user-ID at a mail server of the server system.

With a further embodiment of the invention it may be provided that in the course of registration of the user at the server system payment information is requested, which on the side of the server system is encrypted by means of an encryption key and stored encrypted on the user terminal in a local memory and that an encryption key is exchanged with the server system, which is suitable for decrypting the payment information stored on the user terminal by the transaction server and stored within the server system, preferably within the transaction server.

Further, according to the invention, provision may be made that prior to visiting a website having a product link of the product to be purchased by means of a browser on a user terminal by the user, a communication handler is installed on the user terminal, via which the communication between the user terminal and the server system is processed.

Furthermore provision may be made for the communication handler to be a browser extension, a desktop extension, an app or a snippet integrated with the web site mapping the product link.

According to one embodiment of the method of the invention, in the case that during the execution of a purchasing operation regarding the product in the web shop on the basis on execution data stored in the browser simulation server, a double-opt-in is provided on the side of the vendor by means of a confirmation email, the following additional method steps are provided:
Indication of the email address automatically generated and stored within the server system and assigned to the user, the username or the user-ID;
reading the double-opt-in confirmation email received at the mail-server of the server system;
automatic execution of a confirmation option contained in the double-opt-in confirmation email by the server system, preferably the mail server and/or the browser simulation server, by the web browser on the browser simulation server by forwarding the information from the mail server via the web application server and the transaction server.

By double-opt-in in terms of the invention is understood an express consent procedure, in which the end user must explicitly confirm a purchase transaction—usually by means of an email.

According to a further embodiment of the method of the invention this comprises the following additional method steps:
storing the product link, at least temporarily, transmitted to the web application server in a queue list within the local memory including assigning the username and/or user-ID;
collecting in the queue list further product links assignable to the user, the username and/or the user-ID and transmitted to the web application server by the user terminal prior to initiating the checkout process on the side of the user by means of the checkout trigger;
processing the product links step-by-step in the queue list.

With the proposed method the point of clicking on “checkout” signifies the beginning of the checkout process. The effect of this is that various shops are linked-in via already active affiliate networks, which have grown over the years, without having to interfere with the programming of the shops.

The checkout procedure can be executed by a communication handler on the client side, which means that all steps are carried out in a browser of an internet-enabled communication means on the user side, such as for example a computer or an internet-enabled mobile terminal, and that the user can view the process steps as required. A communication handler in terms of the present invention can for example be a browser extension, a desktop extension, an app or a snippet integrated in the website mapping the product link.

An alternative embodiment provides for the checkout to be executed on the server side, i.e. on the part of a central location (such as a billing location) with the user having to intervene only in case some details have to be amended.

On the user side for example, a browser plugin may be provided in the browser, whereby an “add to central shopping cart” button is added to each of the shop articles. This may be done, for example, by means of frontend-side scripting or by DOM manipulation. Alternatively the button may be integrated into a separate toolbar, if the shop refuses to link a button to its shop contents. In addition the shop may add a JavaScript snippet, whereby the button as well as further functionality would be integrated without having to install a browser extension.

By clicking on the button the product link including diverse article details is stored via the plugin. In addition the customer can drag articles per drag-and-drop into a toolbar, which then, in turn, stores the product link including diverse article details via the plugin. Using frontend-side scripting the URLs retrieved by the user for the desired article as well as the further required ordering parameters (price, quantity, variant selection (e.g. colour, size and similar)) are stored per Ajax call for example via a PHP controller in a database. The necessary data is read from the input fields of the DOM.

The user can view his individual shopping cart via the toolbar (article quantity, total, number of shops).

When the user clicks on the shopping cart he lands on the website of the location of the central shopping cart or alternatively on a layer of that location of the central shopping cart, in which the complete shopping cart is mapped. Here the customer can view the respective products of the shops, enter standard settings for the purchase (billing and delivery address, delivery method(s), payment method(s)) and initiate the purchase transaction.

According to one embodiment of the invention, when the payment methods are selected, the location of the central shopping cart evaluates first the available payment methods of the shops, from which products were added to the shopping cart. Should one of the payment methods not fall into the buyer's preferred selection or if input data is missing, the buyer is prompted to enter this data.

The checkout procedure is triggered with a click on the checkout button or by another suitable user interaction.

According to an alternative embodiment of the invention the articles of the different providers are linked-in per product feed and can be retrieved via a central internet platform. The product feed is a file exported by the shop in a data transmission format such as CSV, JSON, XML or similar or a web service. Here the customer can add the articles to the portal's own shopping cart. The product link including various article details are stored in the shopping cart. By clicking on the shopping cart the customer can view the respective products and information of the shop operator, enter standard settings for the purchase (billing and delivery address, delivery method(s), payment method(s)) and initiate the purchase transaction.

The checkout procedure can be effected in the respective partner shops and performed automatically by the central shopping cart system. The user selects checkout within the browser extension/website/app. The button mapped for this purpose activates an Ajax call for example by frontend-side scripting, which in turn starts the checkout script via a PHP controller.

The product links are sorted by shop URL and processed accordingly, for example by way of PHP functionalities, wherein the data is stored temporarily in PHP arrays and sorted. All product links and the respectively associated number of articles as well as the article variant are then handed over shop by shop. Alternatively provision may be made for the checkout not to be triggered by a link call and click simulation (see above), but by extracting/reading the article number from the article URL or the page of the article URL and sending only GET and/or POST enquiries to the shop in order to place the article into the shopping cart.

In order to add an article to the shopping cart of the respective partner shop, the handed-over product links are retrieved one after the other and deposited in the selected quantity from the central shopping cart into the respective shopping cart of the shop.

Having added all articles the checkout procedure of the shop is ejected in the shopping cart of the partner shop. To this end a click on the link/button of the respective shop, from which the goods originate, is simulated.

In case a login of the user has been filed, the central shopping cart logs into the shop and continues with the checkout procedure.

If no login has been filed, the central shopping cart system completes the registration form with the data stored in the central shopping cart system and a mail address generated by the central shopping cart system. This mail address is read-out as necessary for any double-opt-ins, whereby a click on the double-opt-in link is simulated.

The created login is automatically filed in the central shopping cart system for the next purchases and the login for the purchase transaction is automatically performed after registration.

If the registration requires an input, which is not filed in the central shopping cart system, such as e.g. captchas, the checkout procedure is stopped or paused and the customer is presented with a respective input field. The input is stored in the central shopping cart system and is available for further shopping transactions.

The central shopping cart system automatically selects a payment means which can be preset, such as a credit card, debit card or customer loyalty card. If this does not exist in the shop, the shopping transaction is stopped or paused and the customer can select an alternative payment system.

After selecting a payment method available in the shop and filing the necessary data for the payment, the central shopping cart system automatically performs the payment operation. If inputs from the customer are required, the checkout procedure is stopped and the respective input field presented to the customer.

After the purchasing procedure has been completed for all articles in the shopping cart, the user will receive a confirmation. Should some articles not have been successfully ordered and paid for, this will be indicated to the customer (possibly with replacement suggestions).

As regards the system the requirement of the invention is met by a server system according to claim 10.

Thus a server system is proposed for the processing of internet-based purchase transactions, comprising:
at least one web application server;
at least one transaction server;
at least one browser simulation server;
optionally at least one mail server; and
optionally at least one customer data server,
   wherein the web application server is configured to receive purchasing information on an intended purchase transaction of a user and to confirm the same together with stored user information as well as encrypted payment information to the transaction server, wherein the transaction server comprises means for decrypting encrypted payment information received from the web application server, wherein the transaction server is configured to transmit the encrypted payment information together with the purchasing information and the stored information to the browser simulation server, wherein the transaction server is configured for the communication between web application server and transaction server on the one hand and between transaction server and browser simulation server on the other hand to be effected exclusively via fixed ports with fixed IP addresses being allocated, wherein the server system comprises means for avoiding a direct communication between the web application server and the browser simulation server and wherein the server system comprises means for avoiding a direct communication of the transaction server with the internet, with the exception of a defined service access option.

According to one embodiment of the invention the server system may include a mail server, wherein the mail server and/or the web application server comprise means for automatically creating an email address including allocation of a user, his username and/or a user-ID.

According to a further embodiment of the invention the server system comprises a customer data server for storing preferably purchasing information, username, user-ID, generated email addresses, further user data (210).

It is preferred that the customer data server is configured such that the communication between web application server and customer data server is effected exclusively via fixed ports with fixed IP addresses being allocated, wherein the server system comprises means for avoiding a direct communication between the customer data server and the browser simulation server, wherein the server system comprises means for avoiding a direct communication between the customer data server and the transaction server, wherein the server system comprises means for avoiding a direct communication between the customer data server and the mail server, and wherein the server system comprises means for avoiding a direct communication of the customer data server with the internet, with the exception of a defined service access option.

The invention will now be explained in detail with reference to the attached figures.

FIG. 1 shows a procedure diagram for processing an internet-based purchase transaction of a user (100) at a vendor comprising the steps of:
retrieval, by the user (100), of a product link (131) to the website (132) having the product to be acquired, by means of a browser (110) in a user terminal (101).

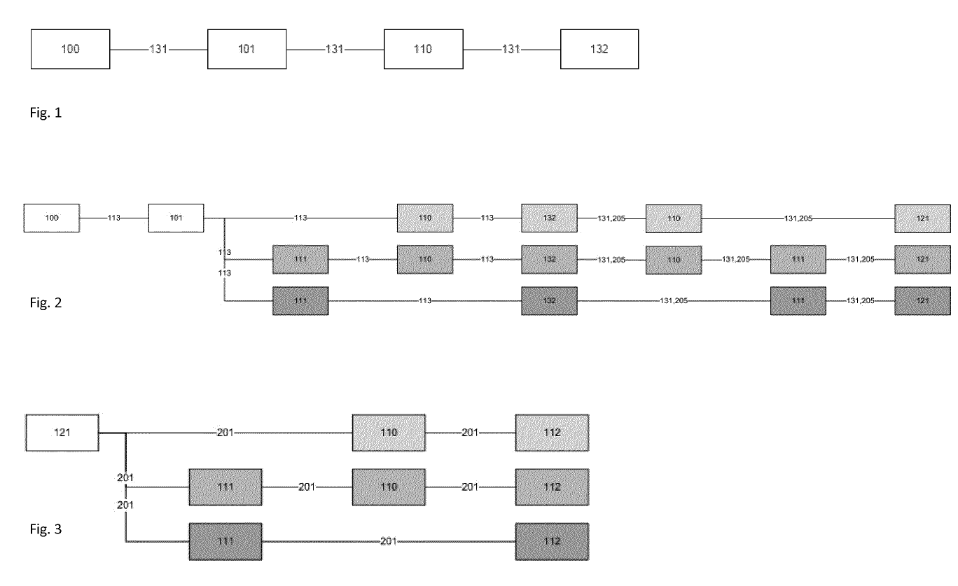

FIG. 2 shows a procedure diagram for a procedure for processing an internet-based purchase transaction of a user (100) at a vendor comprising the steps of:
retrieval, by the user (100), of a product link (131) to the website (132) having the product to be acquired, by means of a browser (110) in a user terminal (101); the user (100) selecting the product corresponding to the product link (131) and article information (205) via the browser (110) by means of an interaction trigger (113) independent of the vendor on the user terminal (101) via the browser (110) on the website (132) mapping the product link;
transmitting the product link (131), and optionally article information (205) to a web application server (121) of a server system.

The communication between server system and browser (110) can be replaced or complemented via a communication handler (111). The communication handler (111) may preferably be an app, a local application, a desktop or browser extension. It may be necessary for the communication handler to be separately installed prior to initial use.

FIG. 3 shows a procedure diagram for an implementation of the method according to the invention, wherein the username (201) comprises an unequivocal user-ID generated by a server (121) of the server system, which upon request of the browser (110) on the user terminal (101) is transmitted by the web application server (121) to the browser (110) on the user terminal. Depending on the way in which the procedure is designed, this may be effected by means of a communication handler (111). Following completion of a registration process the user can log in via the browser (110) on his user terminal on the web application server (121) by entering a username (201) and associated password in addition to the username (201). The login data generated can be stored in a local memory (112) on the user terminal.

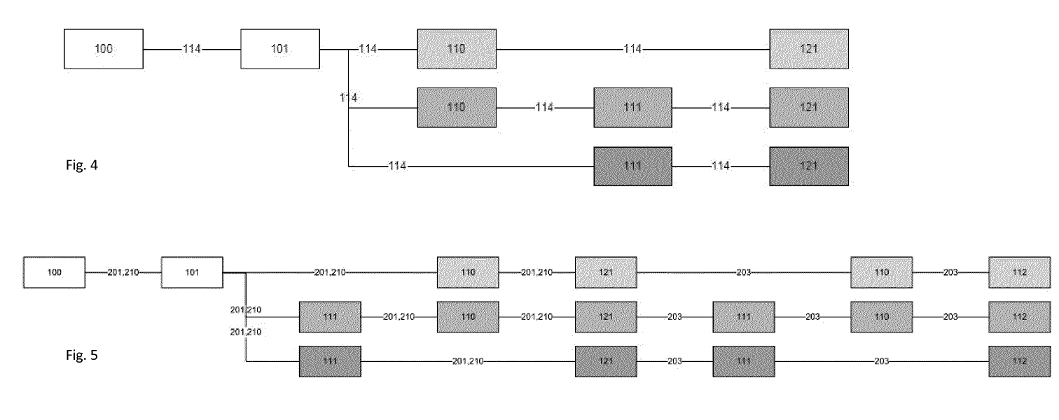

FIG. 4 shows a procedure diagram for an implementation of the method according to the invention comprising the following further steps:
initiation, by the user (100) of a checkout process by means of a checkout trigger (114) via the browser (110).

The communication between the server (121) of the server system and the browser (110) may be replaced or complemented via a communication handler (111).

FIG. 5 shows a procedure diagram for an implementation of the method according to the invention, in which the user (100) creates an account at a web application server (121) of the server system. This may comprise a registration step, in which the user (100) registers with the web application server (121) by preferably indicating at least his email address or telephone number and optionally further user data (210) by means of entering these via the browser or the communication handler (111) on the user terminal (101), and the user (100) is allocated a username (201), wherein the username (201) is stored both within the server system as well as within the user terminal (101) in a local memory (112) taking into account the user-ID (203).

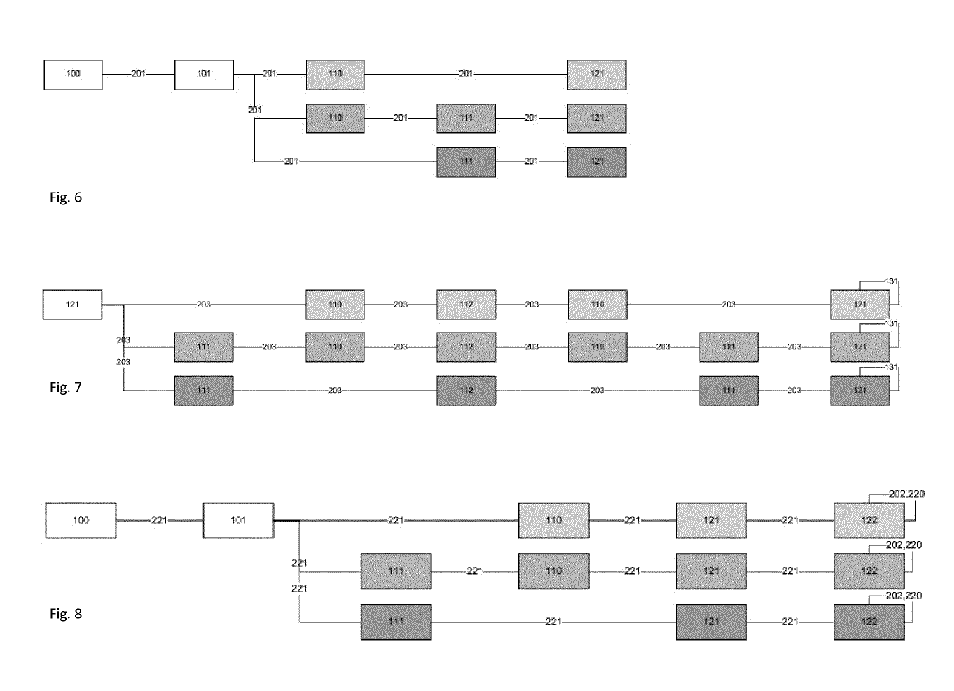

FIG. 6 shows, with regard to an implementation of the method according to the invention, a procedure diagram for the login process of a user (100). Following completion of a registration process the user can log in via the browser (110) on his user terminal on the web application server (121) by entering a username (201) and associated password in addition to the username (201). The communication between the server (121) of the server system and the user terminal (101) und/or the browser (110) may be replaced or complemented via a communication handler (111).

FIG. 7 shows, with regard to an implementation of the method according to the invention, a procedure diagram for combining the username (201) and the purchase transaction data. Following completion of a registration process the user can log in via the browser (110) on his user terminal (101) on the web application server (121) by entering a username (201) and associated password in addition to the username (201). Following the login process the product links (131) assigned to the possibly changed user-ID (203) are stored on the server system, preferably on the web application server (121), and assigned together with the username (201) and user-ID (203) via the browser (110) to the local memory (112). The communication between the server (121) of the server system and the user terminal (101) und/or the browser (110) may be replaced or complemented via a communication handler (111).

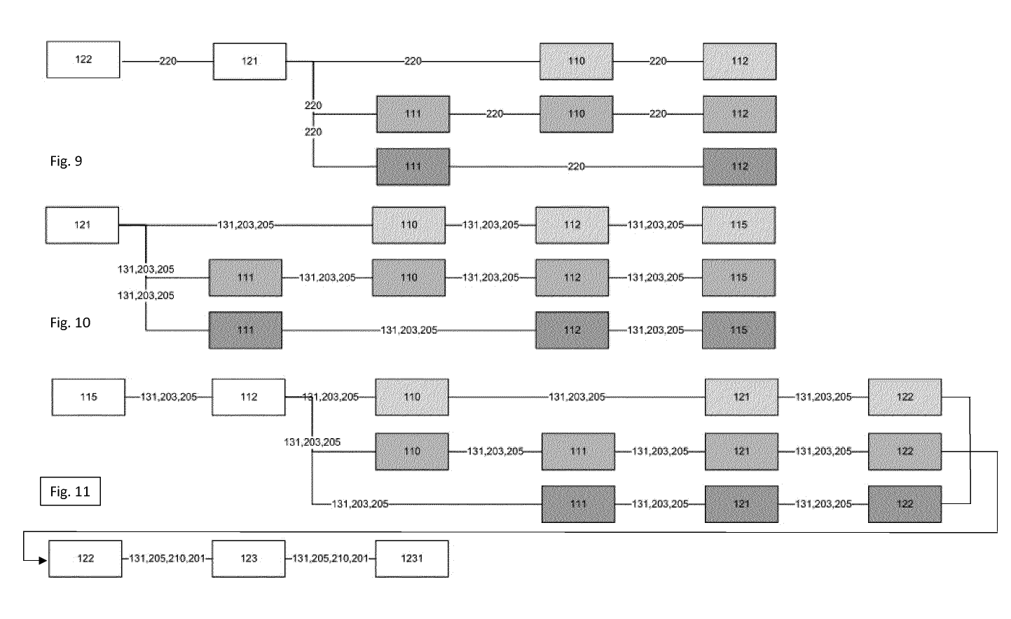

FIGS. 8 and 9, with regard to an implementation of the method according to the invention, show a procedure diagram for the input of payment data. As part of the user's checkout the server system (120) is queried for payment information (220), which on the side of the user terminal (101), via the browser (110), is encrypted by means of an encryption key (202) on a transaction server (122) and then stored back via the web application server (121) and the browser (110) on the user terminal (101) encrypted in a local memory (112). The encryption key (202), which is suitable for decryption of the payment information (220) stored on the user terminal (101) by the transaction server (122), is preferably stored within the server system (120), especially preferably on the transaction server (122).

FIG. 10 shows, with regard to an implementation of the method according to the invention, a procedure diagram for the hand-over of the article information (205), the product link (131) and the username (201) as well as user-ID (203) to a checkout queue. The method comprises the following additional method steps:
storing the product link (131), at least temporarily, transmitted to the web application server (121) and the article information (205) in a queue list (115) within the local memory (112) via the browser (110), including assigning the username (201) and/or user-ID (203);
collecting further product links assignable to the username (201) and transmitted to the web application server (121) from the local memory (112) via the browser (110), in the queue list (115) after initiation of the checkout process on the part of the user (100) by means of the checkout trigger;
processing the product links (131) in the queue list (115) and the associated article information (205) step by step by sending the product links (131), the username (201) and/or the user-ID (203) to the web application server (121). The communication between the server (121) of the server system and the user terminal (101) and/or the browser (110) may be replaced or complemented via a communication handler (111).

FIG. 11 shows, with regard to an implementation of the method according to the invention, a procedure diagram for processing the checkout for a first unfinished shop in the queue list (115). The method comprises the following steps:
retrieving a product link (131) placed in the queue list (115) from the local memory (112) of the user terminal;
transmitting the product link (131) to a web application server (121) of a server system (120) together with a username (201) and/or the user-ID (203 as well as further article information (205);
transmitting the product link (131) as well as optionally further user data (210) stored on a transaction server (122) which is independent of the web application server (121) together with the username (201);
subsequently forwarding the product link (131) together with a username (201) and/or user-ID (203) as well further article information (205) from the transaction server (122) to the browser simulation server (123) and opening a browser (1231) on the browser simulation server (123);
retrieving the product link (131) in the browser (1231) opened on the browser simulation server (123) and simulating the inputs for the further article information (205), the username (201) within the browser (1231);

The communication between the server (121) of the server system and the user terminal (101) and/or the browser (110) may be replaced or complemented via a communication handler (111).

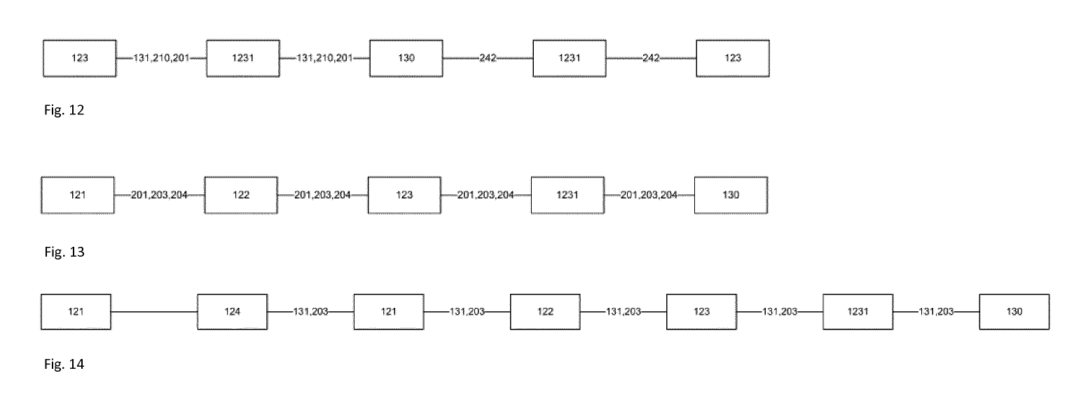

FIG. 12 shows, with regard to an implementation of the method according to the invention, a procedure diagram for the transfer of an article/the product link (131) corresponding to the article (131) and the associated user data (210), as well as the username (201) from the central shopping cart into the respective shopping cart of a shop page (130), as well as returning a status message (242) from the shop page (130) to the browser simulation server (123).

FIG. 13 shows, with regard to an implementation of the method according to the invention, a procedure diagram for creating an account with a web shop (130) by means of an email address (204) generated within the server system and assigned to the user-ID (203) or the username (201).

FIG. 14 shows, with regard to an implementation of the method according to the invention, a procedure diagram for confirming a purchase transaction by means of double-opt-in with a web shop (130) triggered by calling the mail server (124) of the email sent by the web shop (130).

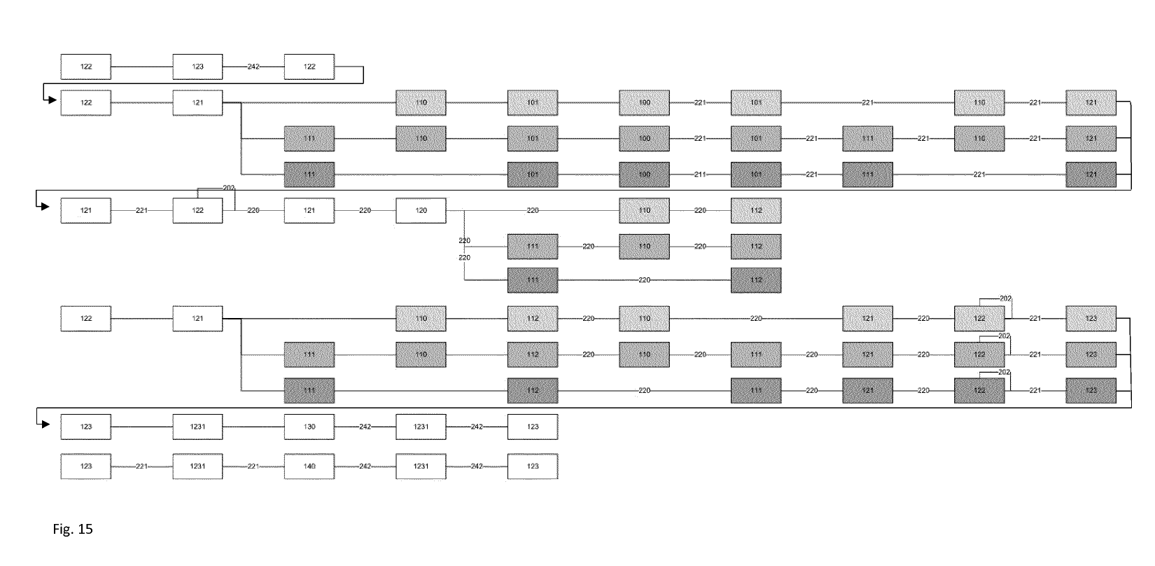

FIG. 15 shows, with regard to an implementation of the method according to the invention, a procedure diagram for executing a payment operation. The method comprises the following method steps:
query by the transaction server (122) to a browser simulation server (123) regarding the possibility of a certain payment option;
replying to the query from the transaction server (122) regarding a certain payment option with yes or no by the browser simulation server (123);
if the reply to the query from the transaction server (122) regarding a certain payment option by the browser simulation server (123) is yes, the following steps are executed:
in case of missing data regarding a certain payment option from the browser simulation server (123), the missing data are queried from the user (100) via the transaction server (122) and the web application server (121) and the non-encrypted/decrypted payment information (221) is transmitted via the web application server (121) to the transaction server (122) for encryption with a generated encryption key (202) and delivery of the encrypted payment information (220) via the web application server to the local memory (112).
querying the encrypted payment information (220) from the local memory (112) via the browser (110) by the web application server (121) and transmission to the transaction server (122);
decrypting the encrypted payment information (220) by means of the encryption key (202) and forwarding the decrypted payment information (221) to the browser simulation server (123);
if the reply to the query from the transaction server (122) regarding a certain payment option by the browser simulation server (123) is no, querying an alternative certain payment option by the transaction server (122) from the browser simulation server (123);
triggering a payment routine regarding the certain payment option in the web shop (130) by the browser simulation server (123);
transmitting the decrypted payment information from the browser simulation server (123) to a payment provider (140) corresponding to the certain payment option;
query by the transaction server (122) to the browser simulation server (123) regarding the completion of the purchase transaction;
confirming completion of the purchase transaction by the browser simulation server (123) to the transaction server (122) with yes or no;
if the reply to the query from the transaction server (122) to the browser simulation server (123) regarding completion of the purchase transaction is yes, a success message is sent to the web application server (121) together with the username (201);
upon receipt of a success message from the transaction server (122) a success message is sent by the web application server (121) to the user terminal (101). The communication between the server (121) of the server system and the user terminal (101) and/or the browser (110) may be replaced or complemented via a communication handler (111).

Reference Symbols:

| | |
|---|---|
| 100 | User |
| 101 | User terminal |
| 110 | Browser |
| 111 | Communication handler |
| 112 | Local memory |
| 113 | Interaction trigger |
| 114 | Checkout trigger |
| 115 | Queue list |
| 120 | Server system |
| 121 | Web application server |
| 122 | Transaction server |
| 123 | Browser simulation server |
| 124 | Mail server |
| 125 | Customer data server |
| 130 | Shop page |
| 131 | Product link |
| 132 | Website having the Product link |
| 139 | Vendor |
| 140 | Payment provider |
| 200 | Purchase information |
| 201 | Username |
| 202 | Encryption key |
| 203 | User-ID |
| 204 | Generated email address |
| 205 | Additional article information |
| 210 | Further user data |
| 220 | Encrypted payment information |
| 221 | Decrypted payment information |
| 231 | Stored execution data |
| 241 | Predefined payments |
| 242 | Status message (yes/no) |
| 1221 | Fixed port |
| 1222 | Fixed port |
| 1223 | Fixed port |
| 1231 | Web browser |

1. A method for processing an internet-based purchase transaction of a user at a vendor, comprising the following steps:
accessing a website comprising a product link of the product to be acquired by means of a browser on a user terminal by the user;
selecting the product corresponding to the product link by the user by means of an interaction trigger independent of the vendor on the user terminal on the website mapping the product link;
transmitting the product link to a web application server of a server system together with a username;
initiating a checkout process on the part of the user by means of a checkout trigger;
transmitting the product link as well as optionally further user data stored on the web application server to a transactions server independent of the web application server together with the username;
transmitting the product link and the further user data from the transaction server to a browser simulation server independent from the transaction server together with the username;
accessing a web shop by opening the product link in a web browser executed on a browser simulation server;
executing a purchase operation with regard to the product in the web shop on the basis of execution data stored in the browser simulation server up to the point of payment options;
query by the transaction server to the browser simulation server regarding the possibility of a certain payment option;
replying to the query by the transaction server regarding a certain payment option by the browser simulation server with yes or no;
if the browser simulation server replies to the query of the transaction server regarding a certain payment option with yes, the following steps are executed:
in case data is missing regarding a certain payment option by the browser simulation server, the missing data is queried via the transaction server and the web application server from the user, and the non-encrypted or decrypted payment information is transmitted via the web application server to the transaction server for encryption using a generated encryption key, the encrypted payment information being supplied via the web application server to the local memory.
retrieving the encrypted payment information from the local memory via the browser by the web application server and transmission via the transaction server;
decrypting the encrypted payment information using the decryption key and forwarding the decrypted payment information to the browser simulation server;
if the browser simulation server replies to the query of the transaction server regarding a certain payment option with no, an alternative certain payment option is requested by the transaction server from the browser simulation server;
triggering a payment routine regarding a certain payment option in the web shop by the browser simulation server;
transmitting the decrypted payment information from the browser simulation server to a payment provider corresponding to the certain payment option;
query from the transaction server to the browser simulation server regarding completion of the purchase transaction;
confirming completion of the purchase transaction by the browser simulation server to the transaction server with yes or no;
if the reply to the query of the transaction server to the browser simulation server regarding completion of the purchase transaction is yes, a success message is transmitted to the web application server together with the username;
upon receipt of a success message by the transaction server a success message is sent by the web application server to the user terminal.

2. The method according to claim 1, wherein the username comprises an unequivocal user-ID generated by a server of the server system, which upon request of the user terminal is transmitted from the web application server to the user terminal.

3. The method according to claim 1, the method comprising, ahead of the step “ . . . transmission of payment information stored encrypted on the user terminal to the web application server . . . ”, a registration step, in which the user registers with the server system at least by submitting his email address or telephone number as well as optionally further user data by means of entering these on the user terminal, and the user is assigned a username and/or a user-ID, wherein the username and/or a user-ID is stored both within the server system and within the user terminal in a local memory.

4. The method according to claim 1, wherein the registration step comprises the automatic creation of an email address assigned to the user, the username and/or the user-ID on a mail server of the server system.

5. The method according to claim 1, wherein during the course of the checkout of the user at the server system payment information is queried, which is encrypted by means of an encryption key on the transaction server and is returned in encrypted form via the web application server to the user terminal and is stored in encrypted form on the user terminal in a local memory, wherein the encryption key which is suitable for decrypting the payment information stored on the user terminal is preferably stored on the transaction server.

6. The method according to claim 1, wherein prior to accessing a website having a product link to the product to be acquired by means of a browser on a user terminal by the user, a communication handler is installed on the user terminal, via which the communication between the user terminal and the server system takes place additionally or completely.

7. The method according to claim 6, wherein the communication handler is a browser extension, a desktop extension, an app or a snippet integrated with the website mapping the product link.

8. The method according to claim 1, wherein the method, in the case that during execution of a purchase transaction regarding a product in the web shop on the basis of execution data filed in the browser simulation server a double-opt-in is provided on the vendor's side by means of a confirmation mail, comprises the following additional steps:
indication of the email address automatically generated and stored within the server system, and assigned to the user, the username or the user-ID;
reading the double-opt-in confirmation email received at the generated email address to the mail server of the server system;
automatic execution of an interaction trigger contained in the double-opt-in confirmation email by the server system, preferably the mail server and/or the browser simulation server by the web browser on the browser simulation server by forwarding the information from the mail server via the web application server and the transaction server.

9. The method according to claim 1, comprising the following method steps:
storing the product link, at least temporarily, transmitted to the web application server in a queue list within the local memory including assigning the username and/or user-ID;
collecting in the queue list further product links assignable to the user, the username and/or the user-ID and transmitted to the web application server by the user terminal prior to initiating the checkout process on the side of the user by means of the checkout trigger;
processing the product links step-by-step in the queue list.

10. A server system for processing internet-based purchase transactions in a majority of users, comprising:
a web application server;
a transaction server; and
a browser simulation server,
wherein the web application server is configured to receive purchasing information on an intended purchase transaction of a user and to transmit this together with stored user information and encrypted payment information to the transaction server, wherein the transaction server comprises means for decrypting the encrypted payment information received from the web application server, wherein the transaction server is configured to transmit the decrypted payment information together with the purchasing information and the stored information to the browser simulation server, wherein the transaction server is configured such that the communication between the web application server and the transaction server on the one hand and transaction server and browser simulation server on the other hand is effected exclusively via fixed ports with fixed IP addresses being assigned, wherein the server system comprises means for avoiding a direct communication between the web application server and the browser simulation server and wherein the server system comprises means for avoiding a direct communication of the transaction server with the internet, with the exception of a defined service access option.

11. The server system according to claim 10, wherein this comprises a mail server, wherein the mail server and/or the web application server comprises means for automatically creating an email address including assigning a user, a username and/or a user-ID.

12. The server system according to claim 11, wherein this comprises a customer data server for preferably storing purchasing information, username, user-ID, generated email addresses, further user data.

13. The server system according to claim 12,
wherein the customer data server is configured such that the communication between web application server and customer data server is effected exclusively via fixed ports including assigning fixed IP-addresses, wherein the server system comprises means for avoiding a direct communication between the customer data server and the browser simulation server, wherein the server system comprises means for avoiding a direct communication between the customer data server and the transaction server, wherein the server system comprises means for avoiding a direction communication between the customer data server and the mail server and wherein the server system comprises means for avoiding a direct communication of the customer data server with the internet, with the exception of a defined service access option.
